(19) United States
(12) Patent Application Publication
(10) Pub. No.: US 2009/0085897 A1
(43) Pub. Date: Apr. 2, 2009

(54) IMAGE DISPLAY APPARATUS

(75) Inventors: Katsumi HIRAKAWA, Sagamihara-shi (JP); Masanao HARA, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS MEDICAL SYSTEMS CORP., Tokyo (JP)

(21) Appl. No.: 12/238,943

(22) Filed: Sep. 26, 2008

Related U.S. Application Data
(60) Provisional application No. 60/995,722, filed on Sep. 28, 2007.

(51) Int. Cl. G09G 5/00; H04N 7/18

(52) U.S. Cl. 345/204; 348/65; 348/E07.085

(57) ABSTRACT

An image display apparatus includes a version detecting unit that detects a version of data about a subject, a control unit that compares at least a part of the version of the data about the subject detected by the version detecting unit with at least a part of a software version of the image display apparatus and that controls processing of the data about the subject based on whether at least the part of the version of the data about the subject is identical with at least the part of the software version, and an output unit that outputs warning information when at least the part of the version of the data about the subject is not identical with at least the part of the software version, the warning information indicating that the version of the data about the subject is not identical with the software version.

### CROSS-REFERENCE TO RELATED APPLICATIONS

This non-provisional application claims the benefit of U.S. Provisional Application Ser. No. 60/995,722, filed Sep. 28, 2007.

### BACKGROUND OF THE INVENTION

1. Field of the Invention

The present invention relates to an image display apparatus for displaying images of the organs of a subject (hereinafter, sometimes referred to as “in-vivo images”).

2. Description of the Related Art

Image display apparatuses have been proposed that are configured to display in-vivo images that are picked up by a capsule endoscope. A capsule endoscope, which is a swallowable endoscope with a capsule case containing an image pickup unit and a wireless communication unit, is to be introduced from the mouth into the alimentary canal of a subject such as a patient. The capsule endoscope sequentially picks up in-vivo images of the subject and wirelessly transmits the in-vivo images to a receiving apparatus provided outside the subject while moving through the alimentary canal depending on peristalsis. Thereafter, an image display apparatus loads the in-vivo images from the receiving apparatus, and displays the in-vivo images on its display (for example, see Japanese Published Japanese Translation No. 2004-521662 of the PCT International Publication).

Such an image display apparatus can be configured to create or edit a report containing comments on in-vivo images of a subject. Specifically, a medical care professional such as a doctor or a nurse operates the image display apparatus to display the in-vivo images of the subject, and sequentially observes the images on the display. The medical care professional sequentially observes the in-vivo images on the display and selects in-vivo images necessary for diagnosing the subject. The medical care professional adds a label and a comment to each selected in-vivo image or each group of selected in-vivo images to smoothly perform a subsequent process for creating a report on the subject.

In response to medical care professional's operation, the image display apparatus displays a thumbnail of selected in-vivo image on a report preparation screen. The medical care professional selects in-vivo images to be contained in the report from the thumbnails of the in-vivo images displayed on the report preparation screen, and groups related in-vivo images. The image display apparatus displays a report generation screen in actual report format, in which the in-vivo image or the group of in-vivo images selected by the medical care professional is displayed. The medical care professional enters a comment etc. on the in-vivo image on the report generation screen. The image display apparatus creates and edits a report on the subject containing the in-vivo image on the report generation screen and the comment entered by the medical care professional.

In some cases, the versions of software for the image processing function and the report editing function of the image display apparatus are different from the versions of the in-vivo image to be processed and the report. The difference between the versions may cause an inconsistency or lack of information originally contained in the report between before and after the edition. This makes it difficult to facilitate the creation of the report on the subject.

Specifically, when an image display apparatus having an old-version report editing function edits a report created by new-version software (i.e., editing a new-version report), text information originally contained in the new-version report (i.e., the report created by the new version software) may be cut from the edited report. On the other hand, when an image display apparatus having a new-version report editing function edits a report created by old-version software (i.e., editing an old-version report), an item (information) not originally contained in the old-version report may be added to or created in the edited report.

When an image display apparatus having a new-version image processing function processes each old-version in-vivo image, the result of the original image processing on each old-version in-vivo image, the display properties such as frame rate, and the format of additional information of each in-vivo image may be changed. This makes it difficult for a medical care professional to distinguish between the in-vivo image processed by the new-version image processing function and the old-version in-vivo image previously selected. For this reason, it has been difficult for medical care specialists to examine a subject by observing in-vivo images of the subject and to facilitate the creation of a report reflecting on the result of examining the subject.

### SUMMARY OF THE INVENTION

An image display apparatus according to an aspect of the present invention includes a version detecting unit that detects a version of data about a subject; a control unit that compares at least a part of the version of the data about the subject detected by the version detecting unit with at least a part of a software version of the image display apparatus, and controls processing of the data about the subject based on whether at least the part of the version of the data about the subject is identical with at least the part of the software version; and an output unit that outputs warning information when at least the part of the version of the data about the subject is not identical with at least the part of the software version, the warning information indicating that the version of the data about the subject is not identical with the software version.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of an in-vivo information acquiring system according to an embodiment of the present invention;

FIG. 2 is a schematic diagram of a display on an image display apparatus according to the embodiment;

FIG. 3 is a schematic block diagram of a configuration of the image display apparatus;

FIG. 4 is a diagram schematically showing examples of the first two bytes of version information embedded in examination data;

FIG. 5 is a diagram schematically showing examples of the third byte of the version information embedded in the examination data;

FIG. 6 is a diagram schematically showing examples of version information of report data;

FIG. 7 is a diagram schematically showing examples of information about a version of image processing having been performed on the examination data;

FIG. 8 is a flowchart of a process performed by the image display apparatus when the examination data and the report data are read;

FIG. 9 is a schematic diagram of examples of a part of the report data stored in XML format;

FIG. 10 is a flowchart of a process for displaying image data contained in the examination data performed by the image display apparatus;

FIG. 11 is a flowchart of a process for processing the report data performed by the image display apparatus;

FIG. 12 is a schematic diagram of an example of a report preparation screen displayed on the image display apparatus;

FIG. 13 is a diagram schematically showing a state in which warning information is displayed on the report preparation screen;

FIG. 14 is a schematic diagram of an example of a report generation screen displayed on the image display apparatus;

FIG. 15 is a schematic diagram of another example of the report generation screen;

FIG. 16 is a diagram schematically showing an example of the state in which warning information is displayed on the report generation screen;

FIG. 17 is a diagram schematically showing another example of the state in which warning information is displayed on the report generation screen;

FIG. 18 is a diagram schematically showing an example of the state in which warning information is displayed near an image on the report preparation screen; and

FIG. 19 is a diagram schematically showing an example of the state in which warning information is displayed near an image on the report generation screen.

### DETAILED DESCRIPTION OF THE PREFERRED EMBODIMENTS

Exemplary embodiments of the present invention are explained in detail below with reference to the accompanying drawings.

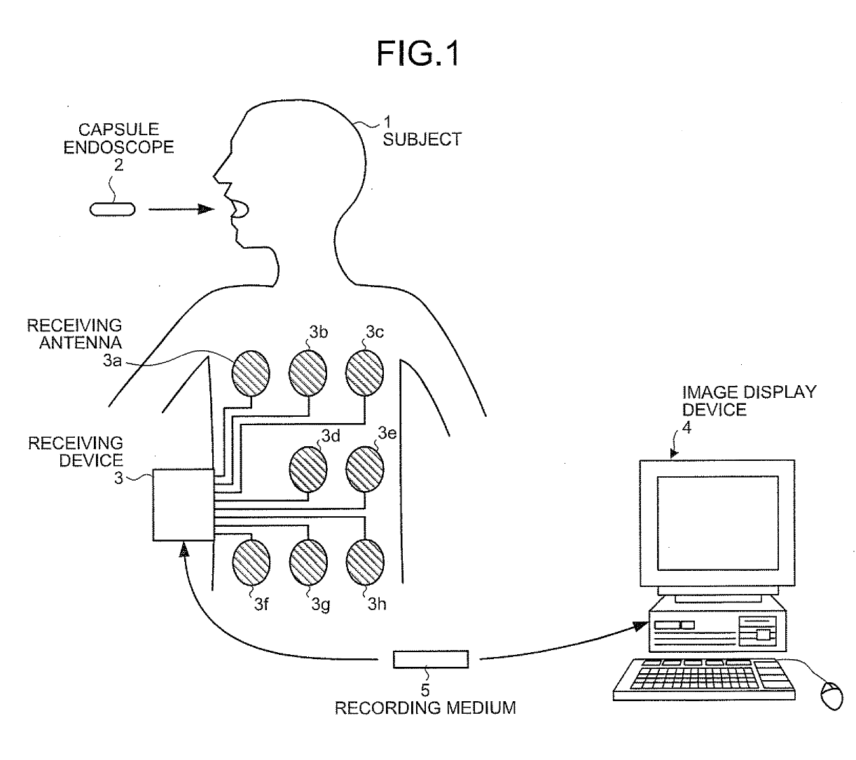

An in-vivo information acquiring system according to an embodiment of the present invention is explained below. FIG. 1 is a schematic diagram of the in-vivo information acquiring system of the embodiment. As shown in FIG. 1, the in-vivo information acquiring system includes a capsule endoscope 2 that picks up an image of the interior of the body of a subject 1 (hereinafter, “in-vivo image”), and a receiving apparatus 3 that receives a wireless signal of the in-vivo image from the capsule endoscope 2 in the subject 1. The in-vivo information acquiring system further includes an image display apparatus 4 that displays the in-vivo image received by the receiving apparatus 3, i.e., picked up by the capsule endoscope 2, and a portable storage medium 5 that stores data to be exchanged between the receiving apparatus 3 and the image display apparatus 4.

The capsule endoscope 2 includes an image pickup unit and a wireless communication unit that are arranged in a capsule case to be introduced into the organs of the subject 1. Specifically, the capsule endoscope 2 is introduced into the organs, for example, from the mouth of the subject 1. Thereafter, the capsule endoscope 2 moves thorough the organs of the subject 1, for example, depending on peristalsis. While moving through the organs, the capsule endoscope 2 sequentially picks up in-vivo images of the subject 1 at predetermined intervals (for example, 0.5 second), and sequentially transmits wireless signals of the in-vivo images to the receiving apparatus 3. Until the capsule endoscope 2 is excreted from the subject 1 to the outside, the capsule endoscope 2 repeats picking up in-vivo images and transmitting wireless signals of picked-up in-vivo images.

The receiving apparatus 3 receives a group of in-vivo images of the subject 1 picked up by the capsule endoscope 2 (hereinafter, “in-vivo image group”). The receiving apparatus 3 includes a plurality of receiving antennas 3a to 3h that are attached to (carried by) the subject 1 into which the capsule endoscope 2 is introduced. Previously, the storage medium 5 is detachably inserted into the receiving apparatus 3. The receiving apparatus 3 receives wireless signals from the capsule endoscope 2 in the subject 1 via at least one of the receiving antennas 3a to 3h, and demodulates the wireless signals to obtain the in-vivo images of the subject 1. The receiving apparatus 3 stores the in-vivo image group in the storage medium 5.

The receiving antennas 3a to 3h can be arranged separately on the body surface of the subject 1 along a route in which the capsule endoscope 2 moves through the interior of the subject 1 (i.e., along the alimentary canal of the subject 1), or on a jacket or the like to be worn by the subject 1. The number of receiving antennas to be connected to the receiving apparatus 3 is not limited to eight as long as at least one receiving antennas is arranged for one subject.

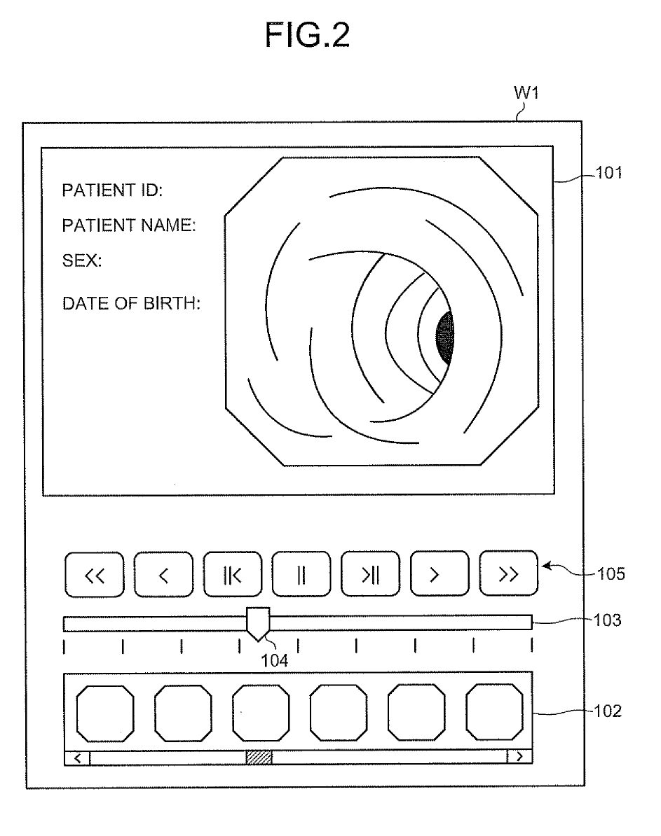

The image display apparatus 4 is configured as, for example a workstation that obtains the in-vivo image group via the storage medium 5 and displays various types of information including the in-vivo image group. FIG. 2 is a schematic diagram of a display on the image display apparatus 4. The image display apparatus 4 displays a window W1 shown in FIG. 2 on which the in-vivo images of the subject 1 of the in-vivo image group are displayed. Specifically, the window W1 includes a main display area 101 on which an in-vivo image is displayed, and a sub display area 102 on which the thumbnails of the in-vivo images are displayed. The window W1 also includes a time bar 103 and a slider 104 that indicate a chronological position of the in-vivo image displayed on the main display area 101, and display operation icons 105 for displaying the in-vivo images. Based on an icon selected from the display operation icons 105 by a user, the image display apparatus 4 successively displays in-vivo images on the main display area 101 as video or displays an in-vivo image as a still image. The slider 104 moves along the time bar 103, and indicates the chronological position of the in-vivo image currently displayed on the main display area 101. Patient information including the patient ID, patient name, sex, date of birth of the subject 1 corresponding to the in-vivo image on the main display area 101 is also displayed on the main display area 101. Each image selected by the user from the images to be displayed on the main display area 101 is displayed as a reduced image on the sub display area 102 as a thumbnail.

The image display apparatus 4 has an image processing function for performing various types of image processing on an in-vivo image and a report processing function for creating or editing a report containing a comment on an in-vivo image (for example, the result of diagnosing the subject 1). The user, such as a doctors diagnoses the subject 1 by observing each in-vivo image of the subject 1 displayed on the window W1, and creates the report about the subject 1 containing the processed in-vivo image and the comment entered by operating the image display apparatus 4. The image display apparatus 4 can edit or output the report data about the subject 1.

The storage medium 5 is portable and used to exchange data between the receiving apparatus 3 and the image display apparatus 4 or between the image display apparatus 4 and an external apparatus such as another image display apparatus. The storage medium 5 is detachably inserted into the receiving apparatus 3 and the image display apparatus 4. When the storage medium 5 is inserted into an apparatus, the storage medium stores therein data or output data. Specifically, when the storage medium 5 is inserted into the receiving apparatus 3, the storage medium 5 stores therein the in-vivo images received by the receiving apparatus 3 from the capsule endoscope 2. When the storage medium 5 is inserted into the image display apparatus 4, the storage medium 5 outputs saved data, such as the in-vivo images or various types of data created by an external apparatus, to the image display apparatus 4.

The saved data in the storage medium 5 is, for example, the in-vivo image group, the chronological data about each in-vivo image of the in-vivo image group, the patient information and examination information about the subject 1, and examination data and report data about another subject created by an external apparatus. The chronological data is, for example, a time when an in-vivo image is picked up or a time when the in-vivo image is received. The patient information about the subject 1 is, for example, the patient name, patient ID, date of birth, sex, and age. The examination information about the subject 1 is, for example, the date on which the subject 1 is examined (hereinafter, “examination date”) and an examination ID of the subject 1.

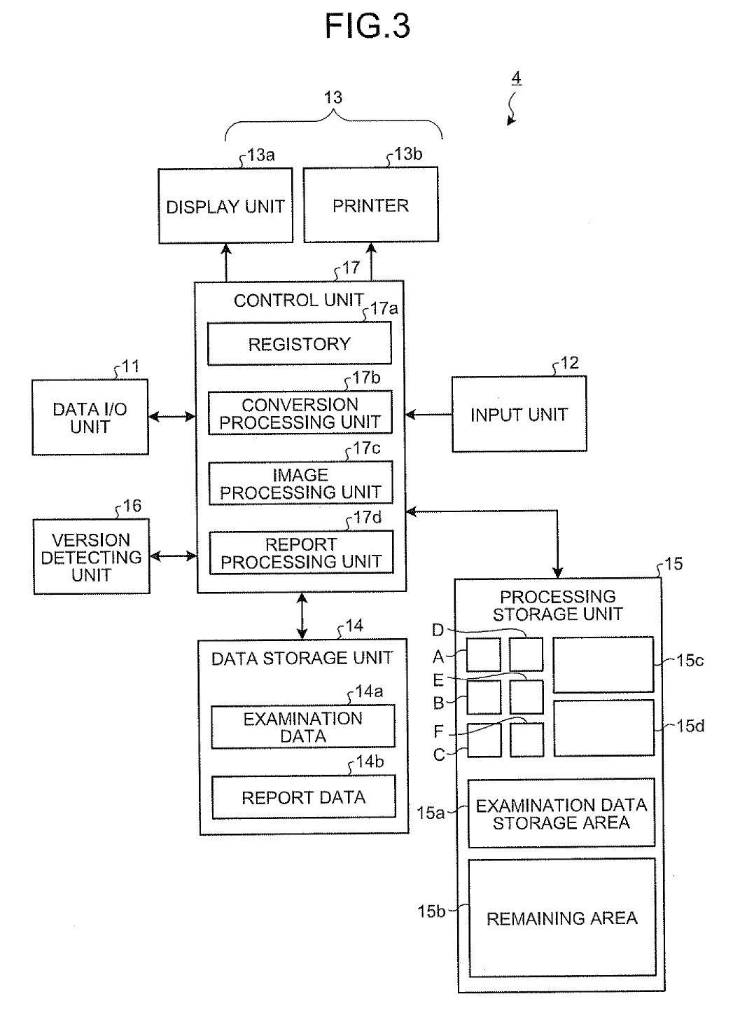

A configuration of the image display apparatus 4 is explained below. FIG. 3 is a schematic block diagram of the configuration of the image display apparatus 4. As shown in FIG. 3, the image display apparatus 4 includes a data input/output (I/O) unit 11, an input unit 12, an output unit 13, a data storage unit 14, a processing storage unit 15, and a control unit 17.

The data I/O unit 11 inputs/outputs various types of data including the in-vivo images of the subject 1. Specifically, when the storage medium 5 detached from the receiving apparatus 3 is detachably inserted into the data I/O unit 11, and the data I/O unit 11 loads the data such as the in-vivo images from the storage medium 5 and inputs the loaded data to the control unit 17. The data I/O unit 11 also outputs, to the storage medium 5, data designated by an instruction from the control unit 17, so that the data is stored in the storage medium 5.

The data loaded by the data I/O unit 11 from the storage medium 5 is, for example, the in-vivo images of the subject 1, the chronological data of each of the in-vivo images, examination data to be processed by the external apparatus, and the report data created and edited by the external apparatus. On the other hand, the data that the data I/O unit 11 stores in the storage medium 5 is, for example, the examination data processed by the image display apparatus 4, the report data created or edited by the image display apparatus 4, and the patient information and examination information about the subject 1.

The input unit 12 is realized using input devices such as a keyboard and a mouse. The input unit 12 receives various types of information to the control unit 17 in response to an input operation by the user. Specifically, based on the control by the control unit 17, the input unit 12 enters a state in which the input unit 12 can receive instruction information for requesting various types of processing, such as an image processing request. In this state, the input unit 12 receives the instruction information to the control unit 17. In addition to the instruction information, the input unit 12 supplies, to the control unit 17, for example, the patient information and examination information about the subject 1 and text data to be contained in the report data.

The output unit 13 outputs various types of data or various types of information designated by an instruction from the control unit 17. The output unit 13 includes a display unit 13a and a printer 13b. The display unit 13a is realized using a display such as a cathode ray tube (CRT) or a liquid crystal display (LCD). The display unit 13a displays the data or information designated by an instruction from the control unit 17. The printer 13b prints (outputs) the data or information designated by an instruction from the control unit 17 on, for example, a paper recording medium. The data or information to be output by the display unit 13a or the printer 13b is, for example, the in-vivo images picked up by the capsule endoscope 2, the data about the subject (hereinafter, “subject data”), or various types of warning information to a user. The subject data is, for example, the examination data and the report data. The warning information to the user indicates that, for example, a software version of the image display apparatus is not identical with a version of the data about the user, or information indicating that converted report data contains data that cannot be displayed but originally displayed in the unconverted report data.

The data storage unit 14 can be a storage media such as a hard disk that stores therein data as rewritable data. The data storage unit 14 stores various types of data specified by an instruction from the control unit 17, and outputs data specified by an instruction from the control unit 17 from the stored various types of data to the control unit 17. The data storage unit 14 stores therein, for example, the data loaded by the data I/O unit 11 and the data input by the input unit 12. The data to be stored in the data storage unit 14 is, for example, the in-vivo image group, the examination data and the report data, and the examination data and the report data about another subject created or edited by the external apparatus.

As shown in FIG. 3, the data storage unit 14 stores examination data 14a and report data 14b. The examination data 14a and the report data 14b can be the subject data, or the data created or edited by the external apparatus, i.e., the data about another subject. The data storage unit 14 stores therein, in addition to the examination data 14a and the report data 14b, a plurality of pieces of examination data and report data including examination data and report data created or edited by the image display apparatus and the external apparatus on a subject basis.

The processing storage unit 15 is a storage medium, such as a random access memory (RAM), an electronically erasable and programmable read only memory (EEPRON), or a flash memory, that stores therein data as rewritable data. Based on the control by the control unit 17, the processing storage unit 15 stores therein the examination data and report data to be processed (hereinafter, “target examination data and target report data”). Specifically, the processing storage unit 15 includes a plurality of storage areas A to F for storing information about conversion processing to be performed on the subject data, an examination data storage area 15a for storing target examination data, and a remaining area 15b that is an auxiliary storage area. The processing storage unit 15 further includes report data storage areas 15c and 15d for storing a new-version of the target report data and an old-version of the target report data separately.

The processing storage unit 15 stores, in the storage area A, information indicating that the old-version report data with respect to the software version of the image display apparatus 4 is converted to a new-version report data corresponding to the software version of the image display apparatus 4. The processing storage unit 15 stores, in the storage area B, information indicating that new-version report data with respect to the software version of the image display apparatus 4 is converted to old-version report data corresponding to the software version of the image display apparatus 4. The processing storage unit 15 stores, in the storage area C, information indicating that a part of the text data originally contained in the report data is cut from the converted report data. The processing storage unit 15 stores, in the storage area D, information indicating that a part of the comment on the thumbnail image or a group of thumbnail images (hereinafter, “thumbnail image group”) originally contained in the report data is cut from the converted report data. The processing storage unit 15 stores, in the storage area E, information indicating that a part of a label on the thumbnail image or the thumbnail image group originally contained in the report data is cut from the converted report data. The processing storage unit 15 stores, in the storage area F, information indicating that the thumbnail image or the thumbnail image group originally contained in the report data is cut from the converted report data. Each of the storage areas A to F enters an ON state when the corresponding information is stored.

The processing storage unit 15 stores, in the examination data storage area 15a, the examination data read from the data storage unit 14 as target examination data. In addition to the target examination data, the processing storage unit 15 stores, in the examination data storage area 15a, the difference between the version of the target examination data and the software version of the image display apparatus 4. The processing storage unit 15 also stores, in the report data storage area 15c or 15d, the report data read from the data storage unit 14 as the target report data. Specifically, when the version of the target report data is newer than the software version of the image display apparatus 4, the new-version report data is stored in the report data storage area 15c. On the other hand, when the version of the target report data is older than the software version of the image display apparatus 4, the old-version report data is stored in the report data storage area 15d. The processing storage unit 15 can be configured to store, in the report data storage area 15c or 15d, the difference between the version of the target report data and the software version of the image display apparatus 4 in addition to the target report data.

The thumbnail image is the data about the in-vivo image contained in the report data, and more specifically, the data about the reduced image of the in-vivo image selected by the user from the in-vivo image group. A thumbnail image group is obtained by grouping the thumbnails.

A version detecting unit 16 detects the version of the subject data based on the control by the control unit 17. Each of the examination data and report data serving as the subject data contains version information indicating the version of software used for creating or editing data. The version detecting unit 16 detects version information from the examination data or the report data specified by an instruction from the control unit 17, and transmits the version information as a result of detecting the version of the examination data or the report data.

The control unit 17 includes a central processing unit (CPU) that executes various types of processing programs for achieving the image processing function and the report processing function, and a memory that stores therein the software of the processing programs. The control unit 17 controls the relevant units (the data I/O unit 11, the input unit 12, the display unit 13a, the printer 13b, the data storage unit 14, the processing storage unit 15, and the version detecting unit 16) of the image display apparatus 4, and controls I/O of signals exchanged between the units. Specifically, the control unit 17 controls operations of the data I/O unit 11, the input unit 12, the display unit 13a, the printer 13b, the data storage unit 14, the processing storage unit 15, and the version detecting unit 16 based on the instruction information input by the input unit 12. For example, the control unit 17 determines whether the version of the examination data or the report data read as the target data from the data storage unit 14 is identical with the software version of the image display apparatus 4. When the versions are not identical, the control unit 17 causes the output unit 13 to output the warning information indicating that the versions are not identical. The control unit 17 can cause the display unit 13a to display the warning information or cause the printer 13b to print out the warning information.

The control unit 17 compares the version of the subject data (the examination data and report data) read as the target data from the data storage unit 14 and the software version of the image display apparatus 4. Based on the result of the comparison, i.e., based on whether the versions are identical, processing of the subject data is controlled. Specifically, the control unit 17 includes a registry 17a, a conversion processing unit 17b, an image processing unit 17c, and a report processing unit 17d. The registry 17a stores therein an allowable range about the text data and the thumbnail images contained in the subject data. Specifically, the allowable range is defined by, for example, the maximum number of characters of a comment to be added to each thumbnail image or each thumbnail image group, the maximum number of characters of a label to be added to each thumbnail image or each thumbnail image group, and the maximum number of thumbnail images to be contained in one piece of report data are stored.

The conversion processing unit 17b performs the conversion processing for converting the target subject data (the examination data and report data) to the target data of the version corresponding to the software version of the image display apparatus 4. Specifically, when the version of the target data is older than the software version of the image display apparatus 4, the conversion processing unit 17b converts the old-version data to data in a new-version data format corresponding to the software version of the image display apparatus 4, so that the version of the target data is updated (upgrading). On the other hand, when the version of the target data is newer than the software version of the image display apparatus 4, the conversion processing unit 17b converts the new-version data to data in an old-version data format corresponding to the software version of the image display apparatus 4, so that the version of the target data is updated (downgraded).

Based on the image processing request input by the input unit 12, the image processing unit 17c performs the image processing corresponding to the software version of the image display apparatus 4 on the image data such as the in-vivo image or the thumbnail image contained in the subject data. Specifically, the image processing unit 17c performs, on the image data contained in the examination data, image processing other than the image processing already performed on the examination data. The image processing unit 17c also performs, on the image data contained in the examination data, image processing of a version newer than that of the image processing already performed on the examination data.

The report processing unit 17d creates the report data containing, for example, the in-vivo image of the subject and the comment on the in-vivo image. Specifically, the report processing unit 17d creates the report data based on the examination data selected by the user and text data such as the comment or the label input by the input unit 12. The report processing unit 17d creates the report data based on the data format corresponding to the software version of the image display apparatus 4. The examination data contains the patient information, examination information, and in-vivo image group of the subject. The image processing unit 17c appropriately performs image processing on each piece of image data contained in the in-vivo image group in the examination data. The report processing unit 17d edits the report data converted by the conversion processing unit 17b based on the information input by the input unit 12. The report data created or edited by the report processing unit 17d is stored in the data storage unit 14.

The control unit 17 permits or prohibits updating the version of the subject data (the examination data or the report data) depending on the authority of the user who has logged-in the image display apparatus 4 (hereinafter, “login user”). Specifically, the user ID, password, and authority of each user are previously set in the control unit 17. The user is, for example, a service person, an administrator, a doctor, or a nurse. Based on the user ID or the password input by the input unit 12 when the image display apparatus 4 performs login processing, the control unit 17 determines the authority of the login user. Depending on the authority of the user, the control unit 17 permits or prohibits updating the version of the target subject data. For example, the control unit 17 permits updating the version of the data when the user is a service person or an administrator, and the control unit 17 prohibits updating the version of the data when the user is a doctor or a nurse.

The software version of the image display apparatus 4 is software version stored in the memory of the control unit 17 and is identical with the version of the processing programs for, for example, the image processing function and the report processing function.

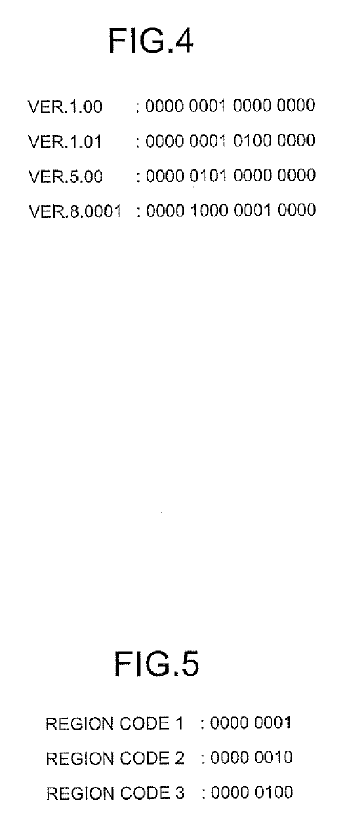

The examination data that is one type of the subject data is explained below. FIG. 4 is a diagram schematically showing examples of the first two bytes of the version information embedded in the examination data. FIG. 5 is a diagram schematically showing examples of the third byte of the version information. The examination data contains the patient information (such as, patient name, patient ID, date of birth, sex, and age) and the examination information (for example, examination ID and examination date), and the in-vivo image group. The in-vivo image group contained in the examination data is the data about images picked up by the capsule endoscope 2.

A plurality of in-vivo images selected by the user from the in-vivo image group can be gathered as a group of images relevant to each other. In addition, a comment or a label that is input by the input unit 12 can be added to each in-vivo image or each in-vivo image group on a comment screen or an observation screen displayed on the display unit 13a.

The examination data is embedded with the version information indicating the version of the examination data (specifically, the version of software with which the examination data is created or edited). Specifically, the first to third bytes of the examination data contains the version information. As shown in FIG. 4, information indicating the version number (for example, Ver.1.00 or Ver.1.01) contained in the version information consists of upper 8 bits (the first byte) corresponding to the integer part of the version number and lower 8 bits (the second byte) corresponding to the decimal part of the version number. The integer part of the version number is stored as a binary number in the upper 8 bits. The decimal part of the version number is stored as a decimal number in the lower 8 bits, in which the upper bits and the lower bits are inverted.

The third byte of the version information of the examination data contains information for specifying a target market (hereinafter, “region code”). For example, as shown in FIG. 5, the region code is stored in the 8 bits of the third byte of the examination data as numerical information that is set on a target market basis. The region code is embedded in the version information of the examination data such that the difference in software that varies depending on the market can be detected.

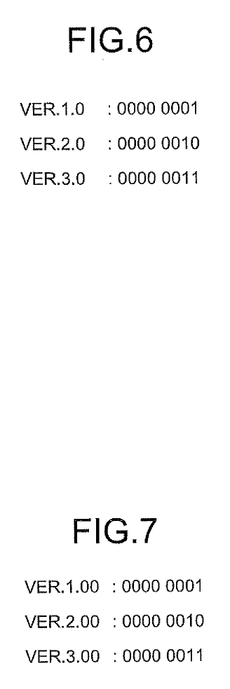

The report data that is one type of the subject data is explained below. FIG. 6 is a diagram schematically showing examples of version information of the report data. The report data contains the patient information (for example, patient name, patient ID, date of birth, sex, and age) and the examination information (for example, examination ID and examination date), facility information about a facility, such as a hospital, where the subject is examined and diagnosed, doctor information about a doctor who examines or diagnoses the subject, at least one in-vivo image of the subject used for examining or diagnosing the subject, the comment on the in-vivo image, and the result of examining the subject. At least one of in-vivo images contained in the report data is data on an image selected by the user from the in-vivo image group in the examination data.

The report data is embedded with the version information indicating the version of the report data (specifically, the version of software with which the report data is created or edited). Specifically, the first byte of the report data contains the version information. As shown in FIG. 6, the version information that indicates the version number of the report data is stored as a binary number in the first 8 bits of the report data. The report data is stored in XML format.

The report data is stored in the data storage unit 14 in a way that what kind of data is contained in the report data is defined by a schema language such as Document Type Definition (DTD). The upper limit of the amount of each type of data to be stored in one type of report data is previously stored in the registry 17a of the control unit 17. In addition, the upper limit of the number of characters of a comment to be added to a thumbnail image and the upper limit of the number of characters of a label to be added to a thumbnail image in one type of report data are previously stored in the registry 17a. The upper limit of the number of thumbnail images to be contained in one type of report data is also previously stored in the registry 17a. The above upper limits may vary depending on the version of report data.

Information about the type and version of each type of image processing having been performed on the examination data (hereinafter, “image processing information”) is explained below. FIG. 7 is a diagram schematically showing the information about the version of image processing having been performed on the examination data. The image processing information is contained in the data subsequent to the version information explained above, i.e., contained in the data from the fourth byte of the examination data.

Specifically, image processing information about red detection processing having been performed on the image data in the examination data is stored in the fourth byte of the examination data, image processing information about average color bar processing having been performed on the image data in the examination data is stored in the fifth byte of the examination data, and image processing information about display rate changing processing having been performed on the image data in the examination data is stored in the sixth byte of the examination data. In addition, 10 bytes of the examination data is secured as an auxiliary data area for storing newly-added image processing. As shown in FIG. 7, the image processing information is stored as, for example, a binary number in data of 8 bits in the examination data. On the other hand, the auxiliary data area of the examination data is filled with values 0.

Among the image-processing versions stored in the examination data, a version not identical with the software version of the image display apparatus 4 is regarded as a difference between an image-processing version and the software version of the image display apparatus 4.

Operations of the image display apparatus 4 are explained below, taking an exemplary case where the image display apparatus 4 processes the examination data and the report data processed by an external apparatus whose software version is different from the software version of the image display apparatus 4.

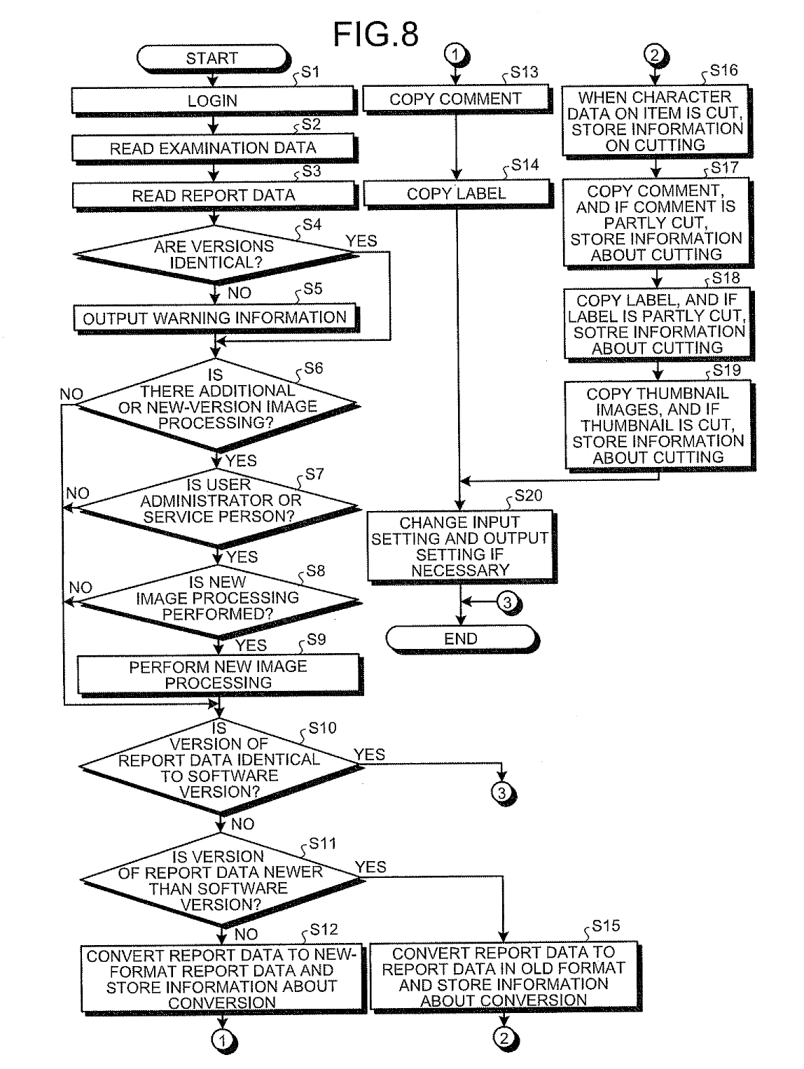

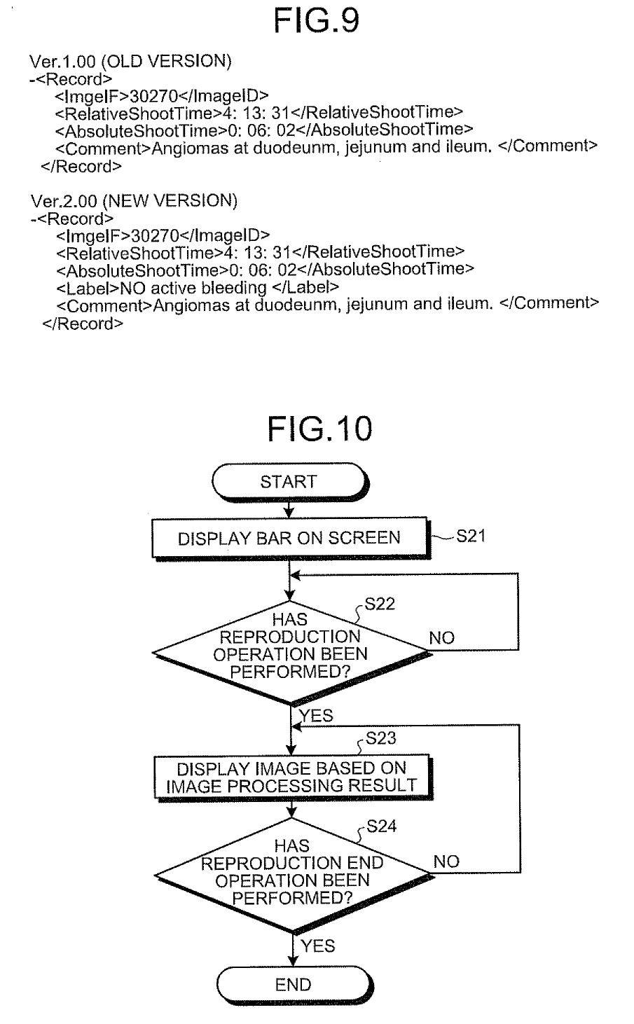

Explained below are the operations performed by the image display apparatus 4 when the examination data and the report data are read. FIG. 8 is a flowchart of a process performed by the image display apparatus 4 when the examination data and the report data are read. FIG. 9 is a schematic diagram of examples of a part of the report data stored in XML format. After the user performs a login operation and logs-in the image display apparatus 4, the image display apparatus 4 performs image processing on the examination data depending on the authority of the user, and appropriately converts the report data to data in a version corresponding to the software version of the image display apparatus 4.

As shown in FIG. 8, the control unit 17 performs login processing in response to the login operation performed by the user (step S1). Specifically, in response to the login operation, the input unit 12 inputs login information about the user including an ID, a password, etc. of the user to the control unit 17. The control unit 17 performs the login processing based on the login information.

Thereafter, the control unit 17 causes the display unit 13a to display an examination data selection screen for selecting target examination data. The user refers to the examination data selection screen on the display unit 13a and selects target examination data by operating the input unit 12. Based on information input by operating the input unit 12 by the user, the control unit 17 reads the examination data 14a from the data storage unit 14 (step S2) as target data, and stores the examination data 14a in the processing storage unit 15.

In response to an operation on the input unit 12 by the user, the control unit 17 causes the display unit 13a to display a report data selection screen for selecting the target report data. The user refers to the report data selection screen, and selects the target report data by operating the input unit 12. Based on information input by operating the input unit 12 by the user, the control unit 17 reads the report data 14b from the data storage unit 14 as target report data (step S3) and stores the report data 14b in the processing storage unit 15.

The control unit 17 determines whether each of the versions of the examination data 14a and the report data 14b, each of which is target data, is identical with the software version of the image display apparatus 4 (step S4). At step S4, the control unit 17 transmits the examination data 14a and the report data 14b to the version detecting unit 16, and causes the version detecting unit 16 to detect the versions of the respective examination data 14a and the report data 14b. Based on the control by the control unit 17, the version detecting unit 16 detects the versions of the examination data 14a and the report data 14b, and transmits the versions to the control unit 17. The control unit 17 compares each of the versions detected by the version detecting unit 16 with the software version of the image display apparatus 4, and determines whether each of the versions of the examination data 14a and the report data 14b is identical with the software version of the image display apparatus 4. When comparing each of the versions of the examination data and the report data with the software version of the image display apparatus, the control unit 17 can compare the versions based on comparison not on all of the version information but on a part of the version information excluding the part not related to data compatibility.

When each of the versions of the examination data 14a and the report data 14b is not identical with the software version of the image display apparatus 4 at step S4 (NO at step S4), the control unit 17 causes the output unit 13 to output the warning information indicating that each of the versions of the examination data 14a and the report data 14b is not identical with the software version of the image display apparatus 4 (step S5).

At step S5, the control unit 17 can cause the display unit 13a to display the warning information or cause the printer 13b to output the warning information. The warning information can be information directly indicating the conflict between the versions. Alternatively, the warning information can be a message saying, for example, “THIS IS NEW-VERSION EXAMINATION DATA OR NEW-VERSION REPORT DATA” indirectly indicating the conflict between the versions.

After the warning information is output, the control unit 17 determines whether the image processing functions of the image display apparatus 4 includes additional image processing or new-version image processing (step S6). At step S6, based on the various types of version information attached to the examination data 14a, the control unit 17 confirms the version of the image processing that has been performed on the examination data 14a. The control unit 17 compares the version of the image processing having been performed on the examination data 14a with the software version of the image display apparatus 4. Based on the result of comparison, the control unit 17 determines whether the image processing functions of the image display apparatus 4 include additional processing or new-version processing, which has not been performed on the examination data 14a.

Additional image processing or new-version image processing not having been performed on the examination data 14a among the image processing functions of the image display apparatus 4 corresponds to a difference between the version information about image processing having been performed on the examination data 14a and the version information about the image processing functions of the image display apparatus 4.

When the image processing functions of the image display apparatus 4 include additional image processing or new-version image processing (YES at step S6), the control unit 17 determines whether the login user is an administrator or a service person (step S7).

The ID, password, and authority (for example, service person, administrator, doctor, or nurse) of each user are previously set in the control unit 17. Based on the information previously set in the control unit 17 and the login information input by the input unit 12 to the control unit 17, the control unit 17 can determine the authority of the login user. If the user is an administrator or a service person (YES at step S7), the control unit 17 specifies the image processing having been performed on the examination data 14a based on the version information about image processing attached to the examination data 14a (for example, the data stored in the fourth byte of the examination data 14a), and determines whether to perform new image processing on the examination data 14a that is one of the image processing functions of, i.e., the additional image processing or the new version image processing not having been performed on the examination data (step S8).

At step S8, the control unit 17 causes the output unit 13 to output information for inquiring whether to perform the new image processing (hereinafter, “query information”) on the examination data 14a. The control unit 17 can cause the display unit 13a to display a message screen displaying the query information. Alternatively, the control unit 17 can cause the printer 13b to output the query information. While the output unit 13 outputs the query information, the control unit 17 causes the input unit 12 to enter a state in which the input unit 12 can receive an image processing request for performing the new image processing on the examination data 14a. When the image processing request is input by the operation on the input unit 12 by the user, the control unit 17 determines to perform the new image processing (YES at step S8) and performs the new image processing on the examination data 14a based on the image processing request (step S9). In other words, when the user is a service person or an administrator, the control unit 17 permits the new image processing to be performed on the examination data 14a. Thereafter, the control unit 17 determines whether the version of the report data 14b is identical with the software version of the image display apparatus 4 (step S10.

When the image processing functions of the image display apparatus 4 does not include additional image processing or new-version image processing (NO at step S6), when the user is not an administrator or a service person (NO at step S7), or when the new image processing is not to be performed on the examination data 14a (NO at step S8), step S9 is not performed and the process control goes to step S10. In other words, when the user is, for example, a doctor or a nurse, the control unit 17 prohibits performing the new image processing on the examination data 14a.

As explained above, the control unit 17 can permit the new image processing to be performed or prohibit perfuming the new image processing on the examination data based on the authority of the login user. This allows a medical care specialist such as a doctor or a nurse to smoothly examine a subject.

At step S10, the control unit 17 compares the version information about the report data 14b detected by the version detecting unit 16 and the software version of the image display apparatus 4, and determines whether the version of the report data 14b is identical with the software version of the image display apparatus 4. When the version of the report data 14b is identical with the software version of the image display apparatus 4 (YES at step S10), the control unit 17 does not convert the report data 14b and completes the process.

On the other hand, when the version of the report data 14b is not identical with the software version of the image display apparatus 4 (NO at step S10), the control unit 17 determines whether the version of the report data 14b is newer than the software version of the image display apparatus 4 (step S11).

When the version of the report data 14b is older than the software version of the image display apparatus 4 (No at step S11), the control unit 17 converts the report data 14b (old version) to data in a new format (hereinafter, “new-format data”) and stores information indicating that the conversion processing is performed so that the old-version report data is converted to the new-format data (hereinafter, “old-to-new conversion information”) (step S12).

At step S12, the conversion processing unit 17b converts the report data 14b (old version) to the new-format data corresponding to the software version of the image display apparatus 4. The conversion processing unit 17b sets to blank an item not originally existing in the report data 14b (old version) in the new-format data. The control unit 17 causes the processing storage unit 15 to store the old-to-new conversion information in the storage area A as an execution history, so that the storage area A enters the ON state. The report data 14b (old-version) is stored in the report data storage area 15d.

The control unit 17 performs comment copy processing for copying the comment on the thumbnail image or the thumbnail image group from the report data 14b (old-version) (step S13) to the new-format data and performs label copy processing for copying the label on the thumbnail image or the thumbnail image group from the report data 14b (old-version) (step S14) to the new-format data. At steps S13 and S14, the conversion processing unit 17b copies the text data of the comment from the report data 14b (old-version) to the new-format data.

Depending on the version, a label on a thumbnail image or a thumbnail image group is set or not set in report data. For example, as shown in FIG. 9, a label tag <Label> for a thumbnail image or a thumbnail image group is set in news version report data (Ver. 2.00) while old-version report data (Ver. 1.00) does not contain the label tag. When the report data 14b (old version) is not compatible with a label for, for example, the thumbnail, the conversion processing unit 17b sets to blank the item for label in the report data 14b in the new format. On the other hand, when the report data 14b (old version) is compatible with a label for, for example, the thumbnail, the conversion processing unit 17b copies the label from the report data 14b (old-version) to the report data 14b in the new format.

Thereafter, the control unit 17 determines whether the language of the report data 14b is different from the setting of the image display apparatus 4, and, if necessary, automatically changes the input setting and display setting of the image display apparatus 4 (step S20) and completes the processing. At step S20, when the language of the report data 14b is different from the input setting of the image display apparatus 4, the control unit 17 changes the input setting of the image display apparatus 4 to one corresponding to the language of the report data 14b. In addition, when the language of the report data 14b is different from the display setting in the image display apparatus 4, the control unit 17 changes the display setting in the image display apparatus 4 to one corresponding to the language of the report data 14b.

At step S11, when the version of the report data 14b is newer than the software version of the image display apparatus 4 (YES at step S11), the control unit 17 converts the report data 14b (new version) to data in an old format (hereinafter, “old-format data”) and stores information indicating that the conversion processing is performed, so that the report data 14b (new version) is converted to the old-format data (hereinafter, “new-to-old conversion information”) (step S15).

At step S15, the conversion processing unit 17b converts the report data 14b (new version) to the old-format data corresponding to the software version of the image display apparatus 4. In this case, the conversion processing unit 17b extracts, from data about items in the report data 14b (new version), data about an item compatible with the old format identical with the format of the software version of the image display apparatus 4, and ignores data about an item not compatible with the old format. In the conversion processing, the conversion processing unit 17b cuts the text data about the item incompatible with the old format, so that the text data of the incompatible item is not displayed on the display unit 13a. The control unit 17 causes the processing storage unit 15 to store the new-to-old conversion information as the execution history in the storage area B, so that the storage area B enters the ON state. The report data 14b (new-version) is stored in the report data storage area 15c.

Thereafter, the control unit 17 copies the text data about each item extracted from the report data 14b (new version) to the old-format data based on the upper limit of the number of characters of each item to be contained in the old-format data. Specifically, when the number of characters in the text data about an item contained in the report data 14b (new version) is not more than the upper limit of the number of characters of the item to be contained in the old-format data, the conversion processing unit 17b copies all the text data from the report data 14b (new version) to the old-format data. On the other hand, when the number of characters in the text data about an item contained in the report data 14b (new version) exceeds the upper limit of the number of characters of the item to be contained in the old-format data, the conversion processing unit 17b copies a part of the text data corresponding to the upper limit from the first character from the report data 14b (new version) to the old-format data, and cuts the rest of the text data. The cut text data cannot be displayed on the display unit 13a as data to be contained in the report. When a part of text data about at least one item originally contained in the report data 14b (new-version) is cut, the control unit 17 stores information indicating that a part of the text data about at least one item originally contained in the report data 14b (new-version) is cut (hereinafter, “item cut information”) (step S16).

At step S16, the control unit 17 causes the processing storage unit 15 to store the item-cut information as the execution history in the storage area C, so that the storage area C enters the ON state.

Thereafter, the control unit 17 copies the comment on the thumbnail image or the thumbnail image group from the report data 14b (new-version) to the old-format data. When a part of the comment is cut, the control unit 17 stores information indicating that a part of the comment is cut (hereinafter, “comment cut information”) (step S17).

At step S17, based on the upper limit of the number of characters in a comment, which is stored in the registry 17a, the conversion processing unit 17b copies the text data about the comment on the thumbnail image or the thumbnail image group from the report data 14b (new version) to the old-format data. Specifically, when the number of characters in the text data about the comment contained in the report data 14b (new version) is not more than the upper limit, the conversion processing unit 17b copies all of the text data about the comment from the report data 14b (new version) to the old-format data. On the other hand, when the number of characters in the text data about the comment contained in the report data 14b (new version) exceeds the upper limit, the conversion processing unit 17b copies a part of the text data about the comment corresponding to the upper limit from the first character from the report data 14b (new version) to the old-format data, and cuts the rest of the text data. The cut text data cannot be displayed on the display unit 13a as data to be contained in the report.

At step S17, when a part of text data about at least a comment originally contained in the report data 14b (new version) is cut, the control unit 17 causes the processing storage unit 15 to store the comment cut information as the execution history in the storage area D, so that the storage area D enters the ON state.

Subsequently, the control unit 17 copies the label on the thumbnail image or the thumbnail image group contained in the report data 14b (new version) to the old-format data. When a part of the label is cut, the control unit 17 stores information indicating that a part of the label is cut (hereinafter, “label cut information”) (step S18).

At step S18, based on the upper limit of the number of characters contained in a label, which is stored in the registry 17a, the conversion processing unit 17b copies the text data about the label on the thumbnail image or the thumbnail image group from the report data 14b (new version) to the old-format data. Specifically, when the number of characters in the text data about the label contained in the report data 14b (new version) is not more than the upper limit, the conversion processing unit 17b copies all of the text data about the label from the report data 14b (new version) to the old-format data. On the other hand, when the number of characters in the text data about the label contained in the report data 14b (new version) exceeds the upper limit, the conversion processing unit 17b copies a part of the text data about the label corresponding to the upper limit from the first character from the report data 14b (new version) to the old-format data, and cuts the rest of the text data. The cut text data cannot be displayed, on the display unit 13a, as data to be contained in the report.

When a part of text data of at least one label originally contained in the report data 14b (new version) is cut, the control unit 17 causes the processing storage unit 15 to store the label cut information as the execution history in the storage area E, so that the storage area E enters the ON state.

Subsequently, the control unit 17 copies the thumbnail images from the report data 14b (new version) to the old-version data. When the thumbnail image is cut, the control unit 17 stores information indicating that the thumbnail image is cut (hereinafter, “thumbnail-mage cut information”) (step S19).

At step S19, based on the upper limit of the number of thumbnail images, which is stored in the registry 17a, the conversion processing unit 17b copies the thumbnail images from the report data 14b (new version) to the old-format data. Specifically, when the number of thumbnail images contained in the report data 14b (new version) is not more than the upper limit, the conversion processing unit 17b copies all of the thumbnail images from the report data 14b (new version) the to the old-format data. On the other hand, when the number of thumbnail images contained in the report data 14b (new version) exceeds the upper limit, the conversion processing unit 17b stores, in the old-format data, the thumbnail images originally contained in report data 14b (new version) corresponding to the upper limit from the first thumbnail image, and cuts the rest of the thumbnail images. The cut thumbnail images cannot be displayed, on the display unit 13a, as data to be contained in the report.

When at least one of the thumbnails originally contained in the report data 14b (new version) is cut, the control unit 17 causes the processing storage unit 15 to store the thumbnail-image cut information as the execution history in the storage area F, so that the storage area F enters the ON state.

Thereafter, the process control goes to step S20. At step S4, when each of the versions of the examination data 14a and the report data 14b is identical with the software version of the image display apparatus 4 (YES at step S4), the step S5 is not performed and the process control goes to step S6.

The operations for displaying the image data contained in the examination data 14a performed by the image display apparatus 4 are explained below. FIG. 10 is a flowchart of a process for displaying the image data contained in the examination data 14a performed by the image display apparatus 4. In response to a display operation by the user, the image display apparatus 4 displays each in-vivo image contained in the examination data 14a on which the new image processing has been performed.

As shown in FIG. 10, the control unit 17 causes the display unit 13a to perform bar display based on the image processing information stored in the examination data 14a that is target examination data (step S21). At step S21, based on the control by the control unit 17, the display unit 13a displays the time bar 103 etc. shown in FIG. 2. When the new image processing is performed on the examination data 14a at step S9 shown in FIG. 8, the control unit 17 causes the display unit 13a to perform the bar display (for example, display an average-color bar in which an average color of each in-vivo image is arranged as a bar) based on the result obtained by performing the new image processing on the examination data 14a.

Subsequently, the control unit 17 determines whether a reproduction operation has been performed by the user (step S22). At step S22, when instruction information for displaying an in-vivo image (hereinafter, “display instruction information”) is input by the input unit 12, the control unit 17 determines that the user has performed the reproduction operation (YES at step S22) and displays the in-vivo image based on the result obtained by processing the examination data 14a (step S23). In response to the reproduction operation performed by the user, the input unit 12 supplies, to the control unit 17, the display instruction information corresponding to any one of the display operation icons 105 shown in FIG. 2.

At step S23, the control unit 17 reflects the result obtained by performing the image processing (for example, the red detection processing or the display rate changing processing) on the examination data 14a on the state of displaying in-vivo images, and displays each in-vivo image contained in the examination data 14a at a display frame rate corresponding to the display instruction information input by the input unit 12.

On the other hand, when the display instruction information is not input at step S22, the control unit 17 determines that the user has not performed the reproduction operation (NO at step S22), and step S22 is repeated.

Thereafter, the control unit 17 determines whether the user has performed a reproduction end operation (step S24). At step S24, when instruction information for ending displaying the in-vivo image (hereinafter, “display ending instruction information”) is input by the input unit 12, the control unit 17 determines that the user has performed the reproduction end operation (YES at step S24) and causes the display unit 13a to end reproducing the in-vivo image, and the processing is completed. At step S24, when the display end instruction information is not input by the input unit 12, the control unit 17 determines that the user has not performed the reproduction end operation (NO at step S24), and the process control goes back to step S23 and step S23 and the subsequent steps are repeated.

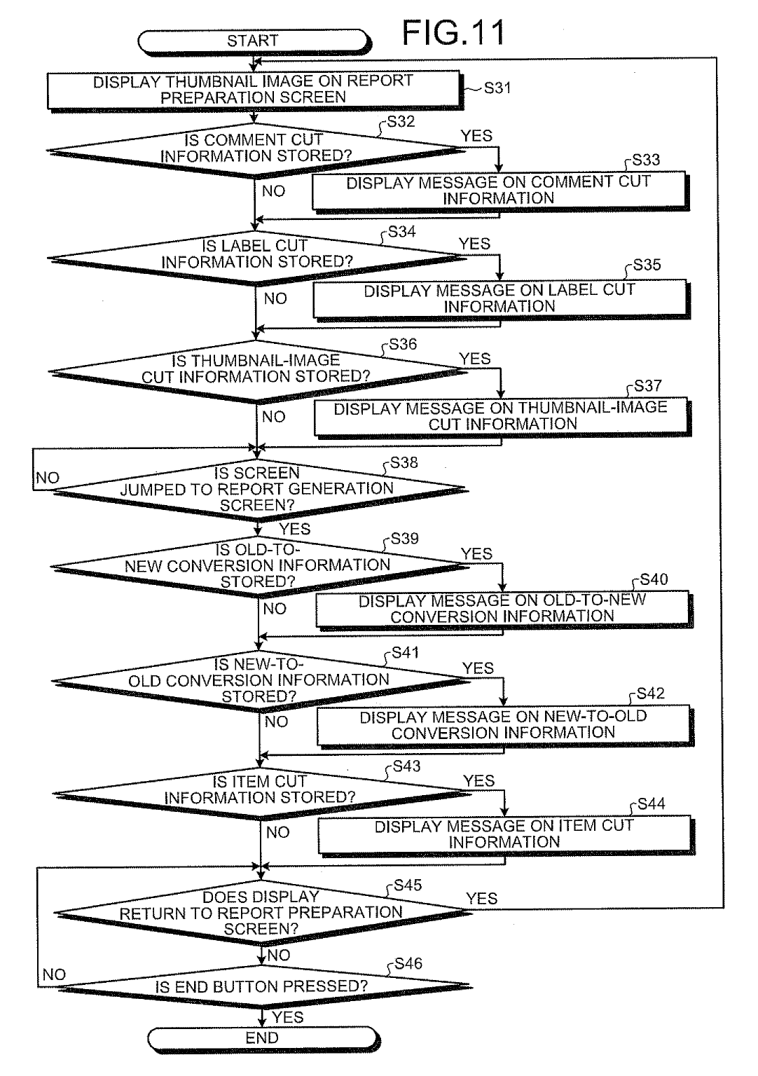

The operations for processing the report data performed by the image display apparatus 4 are explained below. FIG. 11 is a flowchart of a process for processing the report data performed by the image display apparatus 4. When the report data 14b converted in conformity with the software version of the image display apparatus 4 is displayed on the display unit 13a, warning information that should be addressed to the user when creating or editing the report data 14b is displayed on the display unit 13a.

As shown in FIG. 11, based on the instruction information input by the input unit 12, the control unit 17 causes the display unit 13a to display the report preparation screen in a predetermined format, and causes the display unit 13a to display the thumbnail images contained in the report data 14b on the report preparation screen (step S31).

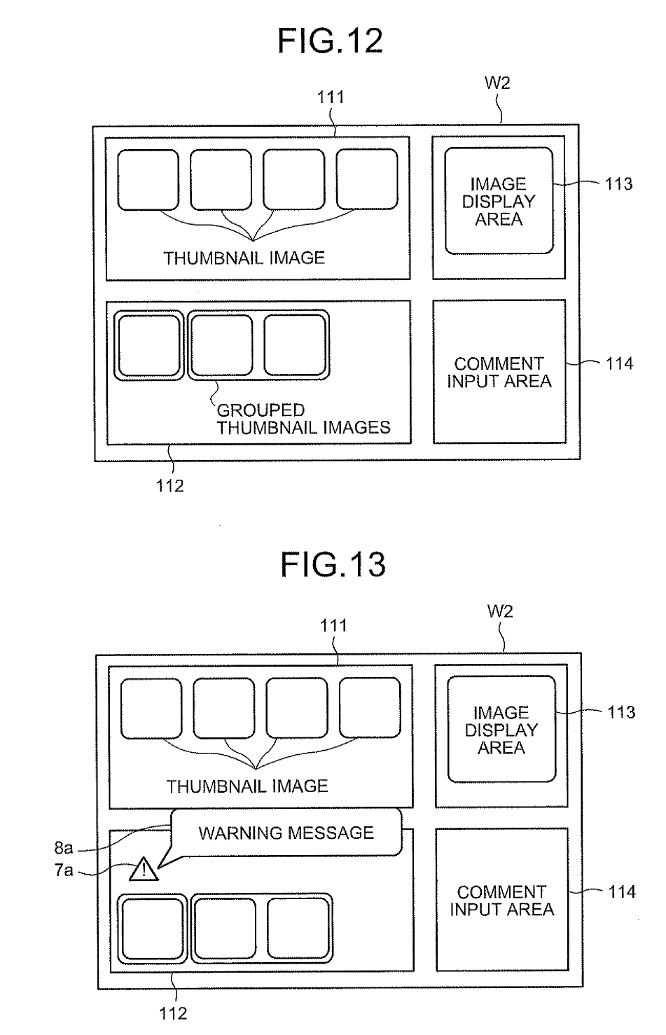

At step S31, the control unit 17 causes the display unit 13a to display, for example, a window W2 shown in FIG. 12 as the report preparation screen. The window W2 includes a thumbnail image display area 111, an image group display area 112, an image display area 113, and a comment input area 114. Based on the control by the control unit 17, the display unit 13a displays all of the thumbnail images contained in the report data 14b. In addition, in response to an operation on the input unit 12 by the user, the control unit 17 causes the display unit 13a to select a thumbnail image to be contained in the report from the thumbnail images in the thumbnail image display area 111 and to display the selected thumbnail image on the image display area 113. Furthermore, in response to an operation on the input unit 12 by the user, the control unit 17 causes the display unit 13a to group thumbnail images out of the thumbnail images in the thumbnail image display area 111 and to display the grouped thumbnail images in the image group display area 112. When a comment on the thumbnail image or the thumbnail image group is input by the input unit 12, the control unit 17 causes the display unit 13a to display text data on the comment in the comment input area 114.

While the thumbnail images are displayed in the window W2, the control unit 17 determines whether the comment cut information on the report data 14b is stored (step S32). At step S32, when the storage area D is in the ON state, the control unit 17 determines that the comment cut information is stored (YES at step S32) and displays a message about the comment cut information (step S33).

At step S33, the control unit 17 causes the display unit 13a to display a warning message at least clearly indicating that the comment has been partly cut (hereinafter, “comment-cut warning message”) as comment-cut warning information. The control unit 17 causes the display unit 13a to display, for example, as shown in FIG. 13, a mark 7a “!” that is one of the comment-cut warning information near the thumbnail image from which the comment has been partly cut. Furthermore, the control unit 17 causes the display unit 13a to display the comment-cut warning message in a tool chip 8a pointing the mark 7a as the warning information.

The comment-cut warning information can include, in addition to the message indicating that the comment has been partly cut (i.e., there is text data about the comment that cannot be displayed), a message that recommends updating the software version of the image display apparatus 4. In other words, the control unit 17 can cause the display unit 13a to display, as the comment-cut warning information, a message clearly indicating that the comment has been partly cut and recommending updating the software version. In this case, for example, a warning message saying “THE REPORT IS GENERATED BY NEW-VERSION SOFTWARE. COMMENT HAS BEEN CUT. UPDATING SOFTWARE VERSION IS RECOMMENDED” is displayed in the tool chip 8a shown in FIG. 13.

Subsequently, the control unit 17 determines whether the label cut information on the report data 14b is stored (step S34). At step S32, when the storage area D is not in the ON state, the control unit 17 determines that the comment cut information is not stored (NO at step S32). In this case, step S33 is not performed and the process control goes to step S34. At step S34, when the storage area E is in the ON state, the control unit 17 determines that the label cut information is stored (YES at step S34), and displays a message about the label cut information (step S35).

At step S35, the control unit 17 causes the display unit 13a to display a warning message at least clearly indicating that the label has been partly cut (hereinafter, “label cut warning message”) as label-cut warning information. In this case, as in the case of the comment cut warning information, the control unit 17 causes the display unit 13a to display, as the label cut waning information, for example, the mark 7a and the tool chip 8a in which the label cut waning information is displayed.

The label-cut warning information can include, in addition to the message indicating that the label has been partly cut (i.e., there is text data about the label that cannot be displayed), a message that recommends updating the software version of the image display apparatus 4. In other words, the control unit 17 can cause the display unit 13a to display, as the label-cut warning information, a message clearly indicating that the label has been partly cut and recommending updating the software version. In this case, for example, a warning message saying “THE REPORT IS GENERATED BY NEW-VERSION SOFTWARE. LABEL HAS BEEN CUT. UPDATING SOFTWARE VERSION IS RECOMMENDED” is displayed in the tool chip 8a shown in FIG. 13.

Subsequently, the control unit 17 determines whether the thumbnail-image cut information on the report data 14b is stored (step S36). At step S34, when the storage area E is not in the ON state, the control unit 17 determines that the label cut information is not stored (NO at step S34). In this case, step S35 is not performed and the process control goes to step 536. At step S36, when the storage area F is in the ON state, the control unit 17 determines that the thumbnail-image cut information is stored (YES at step S36), and displays a message about the thumbnail-image cut information (step S37).

At step S37, the control unit 17 causes the display unit 13a to display a warning message at least clearly indicating that the thumbnail image has been partly cut (hereinafter, “thumbnail-image cut warning message”) as thumbnail-image cut warning information. The control unit 17 causes the display unit 13a to display, for example, the mark 7a in, for example, the thumbnail image display area 111 or the image group display area 112 of the window W2 shown in FIG. 12. Furthermore, the control unit 17 causes the display unit 13a to display, as the warning information, the thumbnail-image cut warning message in the tool chip 8a pointing the mark 7a.

The thumbnail-image cut warning information can include, in addition to the message indicating that the thumbnail image has been cut (i.e., there is a thumbnail image that cannot be displayed), a message that recommends updating the software version of the image display apparatus 4. In other words, the control unit 17 can cause the display unit 13a to display, as the thumbnail-image cut warning information, a message clearly indicating that the thumbnail image has been partly cut and recommending updating the software version. In this case, for example, a warning message saying “THE REPORT IS GENERATED BY NEW-VERSION SOFTWARE. THUMBNAIL IMAGE HAS BEEN CUT. UPDATING SOFTWARE VERSION IS RECOMMENDED” is displayed in the tool chip 8a shown in FIG. 13.

The control unit 17 determines whether to jump to the report generation screen (step S38). At step S36, when the storage area F is not in the ON state (No at step S36), step S37 is not performed and the process control goes to step S38.

At step S38, when instruction information for jumping to the report generation screen (hereinafter, “jump instruction information”) is input by the input unit 12, the control unit 17 determines to jump to the report generation screen based on the jump instruction information (YES at step S38) and causes the display unit 13a to change the report preparation screen to the report generation screen. The jump instruction information is supplied to the control unit 17 in response to an operation on the input unit 12 by the user, for example, by selecting a button for jumping to the report generation screen.

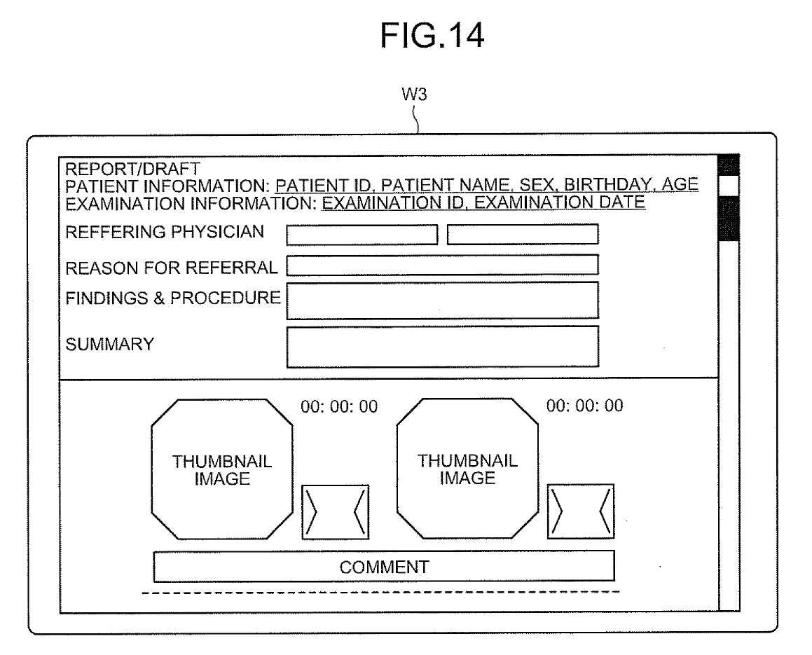

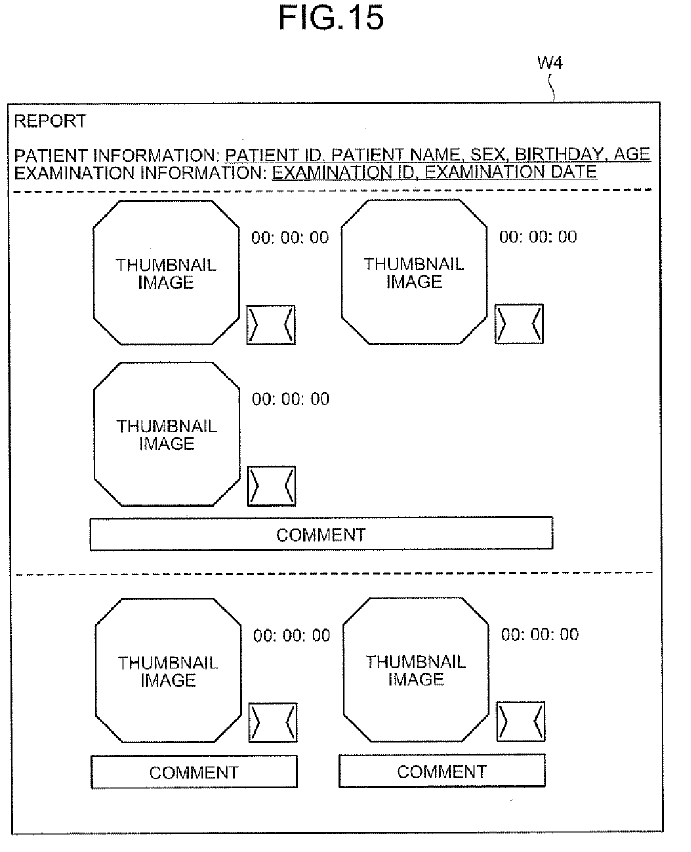

Based on the control by the control unit 17, the display unit 13a displays, for example, a window W3 shown in FIG. 14 or a window W4 shown in FIG. 15. Both the windows W3 and W4 are used to create a report on the subject. On each of the windows W3 and W4, information such as the thumbnail image and the comment selected and input on the report preparation screen, the patient information, the examination information etc. are displayed.

At step S38, when the jump instruction information is not input, the control unit 17 determines not to jump to the report generation screen (NO at step S38) and step S38 is repeated until the input unit 12 inputs the jump instruction information.

While the report generation screen is displayed on the display unit 13a at step S38, the control unit 17 determines whether the old-to-new conversion information on the report data 14b is stored (step S39). At step S39, when the storage area A is in the ON state, the control unit 17 determines that the old-to-new conversion information is stored (YES at step S39) and displays a message about the old-to-new conversion information (step S40).

At step S40, the control unit 17 causes the display unit 13a to display a warning message at least clearly indicating that the report data 14b has been converted from the old version to the new version (hereinafter, “old-to-new conversion warning message”) as old-to-new conversion warning information. The control unit 17 causes the display unit 13a to display the tool chip 8 on which the old-to-new conversion warning message is displayed and the mark 7a on the report generation screen.

The old-to-new conversion warning information can include, in addition to the old-to-new conversion warning message, a message that recommends updating the software version of the image display apparatus 4. In other words, the control unit 17 can cause the display unit 13a to display, as the old-to-new conversion warning information, a message clearly indicating that the report data 14b has been converted from the old version to the new version and recommending updating the software version.

Subsequently, the control unit 17 determines whether the new-to-old conversion information on the report data 14b is stored (step S41). At step S39, when the storage area A is not in the ON state, the control unit 17 determines that the old-to-new conversion information is not stored (NO at step S39). In this case, step S40 is not performed and the process control goes to step S41. At step S41, when the storage area B is in the ON state, the control unit 17 determines that the new-to-old conversion information is stored (YES at step S41), and displays a message about the new-to-old conversion information (step S42).

At step S42, the control unit 17 causes the display unit 13a to display a warning message at least clearly indicating that the report data 14b has been converted from the new version to the old version (hereinafter, “new-to-old conversion warning message”) as new-to-old conversion warning information. The control unit 17 causes the display unit 13a to display the tool chip 8a on which the new-to-old conversion warning message is displayed and the mark 7a on the report generation screen.

The new-to-old conversion warning information can include, in addition to the new-to-old conversion warning message, a message that recommends updating the software version of the image display apparatus 4. In other words, the control unit 17 can cause the display unit 13a to display, as the old-to-new conversion warning information, a message clearly indicating that the report data 14b has been converted from the new version to the old version and recommending updating the software version.

Subsequently, the control unit 17 determines whether the item cut information on the report data 14b is stored (step S43). At step S41, when the storage area B is not in the ON state, the control unit 17 determines that the new-to-old conversion information is not stored (NO at step S41). In this case, step S42 is not performed and the process control goes to step S43. At step S43, when the storage area C is in the ON state, the control unit 17 determines that the item cut information is stored (YES at step S43), and displays a message about the item cut information (step S44).

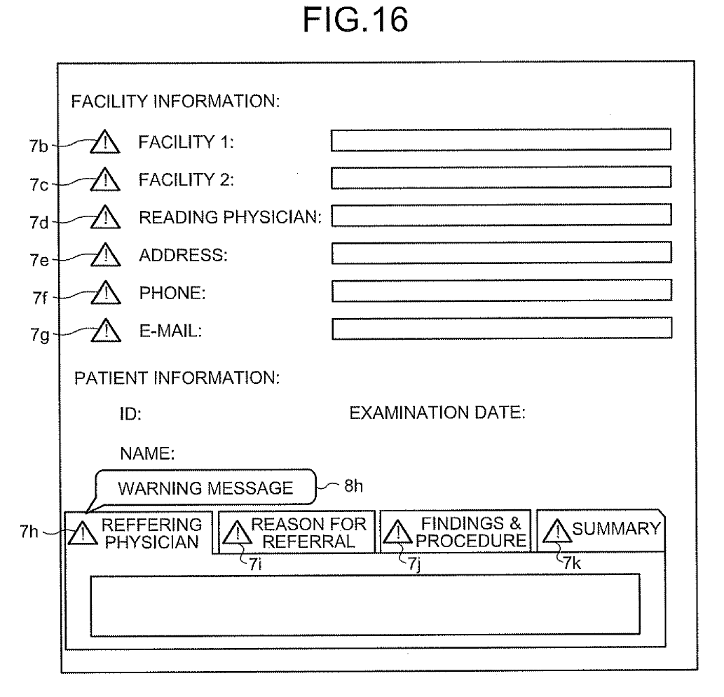

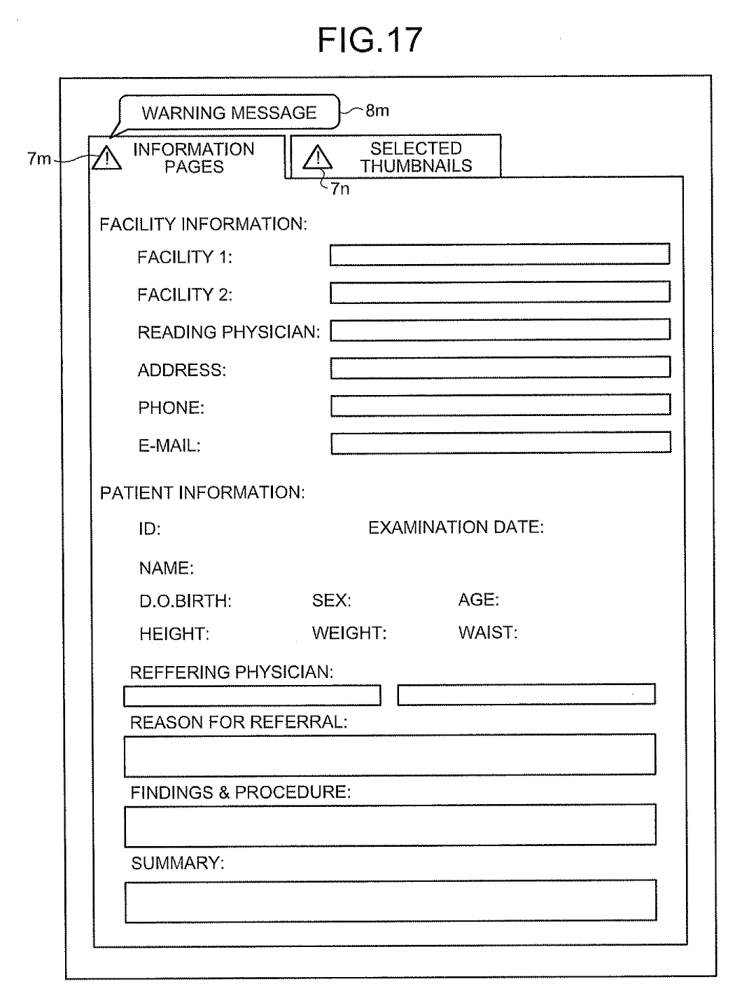

At step S44, the control unit 17 causes the display unit 13a to display a warning message at least clearly indicating that a part of the text data about at least one item originally contained in the report data 14b is cut (hereinafter, “item cut warning message”) as item cut warning information. Specifically, as shown in FIGS. 16 and 17, the control unit 17 causes the display unit 13a to display marks 7b to 7k or marks 7m and 7n represented by, for example, “!” as the item cut warning information in each item from which information is cut. The control unit 17 causes the display unit 13a to display the item cut warning message corresponding to a mark (item) selected from the marks 7b to 7k or the marks 7m and 7n in a tool chip pointing the selected mark. For example, the mark 7h is selected and the item cut warning message corresponding to the mark 7h is displayed in a tool chip 8h pointing the mark 7h as shown in FIG. 16, or the mark 7m is selected and the item cut warning message corresponding to the mark 7m is displayed in a tool chip 8m pointing the mark 7h as shown in FIG. 17.

It suffices that the item cut warning information contains at least the item cut warming message. The item cut warning information can include, in addition to the item cut waning message, a message for giving a warning to data management, a message indicating that there is text data of an item that cannot be displayed, and a message that recommends updating the software version of the image display apparatus 4. In this case, for example, a warning message saying “THE REPORT IS GENERATED BY NEW-VERSION SOFTWARE. SOME FUNCTIONS MAY NOT BE AVAILABLE. BECAUSE TEXT DATA IS CUT, LACK OF INFORMATION MAY BE CAUSED BEFORE DATA IS SAVED. UPDATING SOFTWARE VERSION IS RECOMMENDED” is displayed as the item cut warning information.

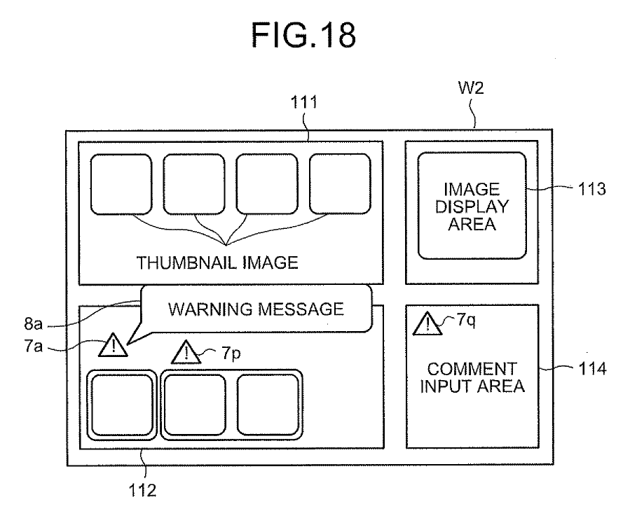

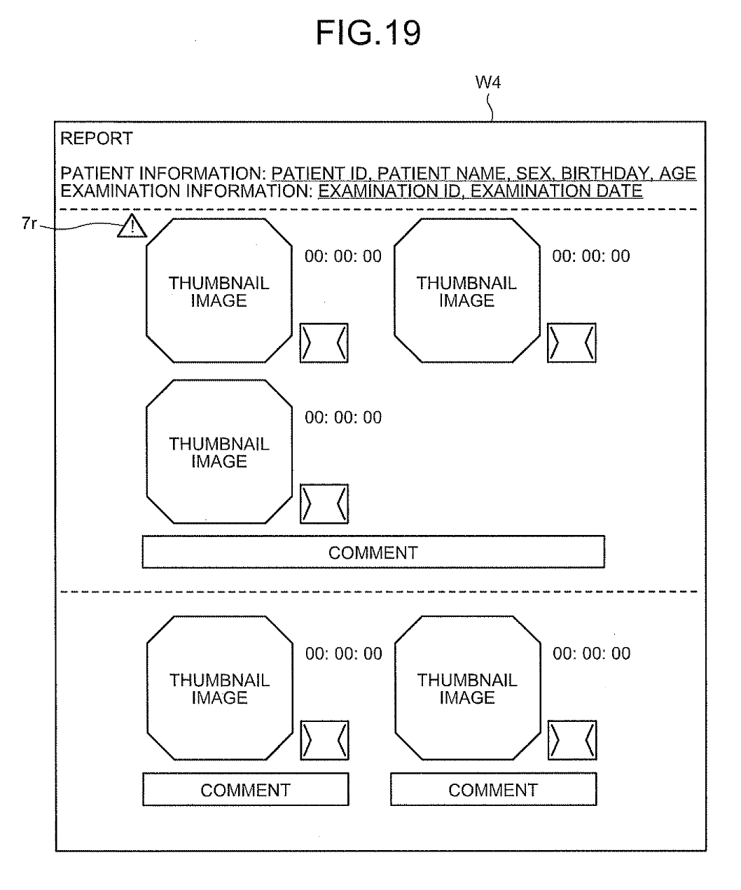

When the comment or the label on the thumbnail image or the thumbnail image group selected by the user on the report preparation screen has been partly cut, the display unit 13a can display the mark 7a and a mark 7p as a warning near the corresponding thumbnail image or the corresponding thumbnail image group as shown in FIG. 18. When the comment or the label from which a part of the comment or the label is displayed in the comment input area 114, the display unit 13a can display a mark 7q as a warning in the comment input area 114. When the label or the comment on the thumbnail image selected by the user on the report generation screen has been partly cut, the display unit 13a can display a mark 7r near the thumbnail image as shown in FIG. 19. The display unit 13a can display the warning messages provided above collectively in one dialogue.

After step S44, the control unit 17 determines whether the display returns from the report generation screen to the report preparation screen (step S45). At step S43, when the storage area C is not in the ON state, the control unit 17 determines that the item cut information on the report data 14b is not stored (NO at step S43). In this case, step S44 is not performed and the process control goes to step S45.

At step S45, when instruction information for causing the display to return from the report generation screen to the report preparation screen (hereinafter, “return instruction information”) is input by the input unit 12, the control unit 17 determines to cause the display from the report generation screen to the report preparation screen based on the return instruction information (YES at step S45). In this case, the process control goes back to step S31 and step S31 and the subsequent steps are repeated. In response to an operation on the input unit 12 by the user, the return instruction information is supplied to the control unit 17.

On the other hand, when the return instruction information is not input by the input unit 12, the control unit 17 determines not to cause the display to return from the report generation screen to the report preparation screen (NO at step S45) and determines whether the user presses an end button (step S46). When instruction information for completing the processing (hereinafter, “completion instruction information”) is input by the input unit 12, the control unit 17 determines that the end button is pressed (YES at step S46) and ends the application. On the other hand, when the completion instruction information is not input, the control unit 17 determines that the completion button has not been pressed (NO at step S46). In this case, process control goes back to step S45, and step 45 and the subsequent steps are repeated.

As explained above, in the image display apparatus 4, in vivo images are explained as the in-vivo information. Alternatively, the body temperature or the pH value of the subject can be used as the in-vivo information. In other words, the capsule endoscope 2 can be configured not only to pick up in-vivo images but also to obtain information about, for example, the body temperature or the pH value of the subject.

As explained above, in the image display apparatus 4, changing the version of the examination data 4a is permitted or prohibited depending on the authority of the user who has logged in the image display apparatus 4. Alternatively, changing the version of report data 4b can be permitted or prohibited depending on the authority of the user who has logged in the image display apparatus 4.

As explained above, in the image display apparatus 4, the data I/O unit 11 loads the data from the portable storage medium 5 as the subject data, i.e., the examination data 4a or the report data 4b. Alternatively, the data I/O unit 11 can be configured to connect to, for example, a communication network and obtain the subject data from an external apparatus or an external database.

As explained above, in the image display apparatus 4, waning information such as the information indicating that the version of the target data is different from the software version of the processing function is displayed on the screen or printed out. Alternatively, such warning information can be output as audio information or a combination of display information and audio information.

As explained above, the image display apparatus 4 is configured to detect the version of the subject data, determine whether the version of the subject data is identical with the software version of the processing function, control processing the target data depending on whether the versions are identical, and output the warning information indicating that, for example, the versions are not identical with each other. This makes it possible to notify the user of the fact that a lack of information in the report or incoherence in information occurs, i.e., the incompatibility affects the subject data. This gives a warning about the data to be used for the report on the subject to the user, which allows the user to smoothly examine the subject or creating the report even if the software version and the version of the target data are not identical with each other.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image display apparatus comprising:
a version detecting unit that detects a version of data about a subject;
a control unit that compares at least a part of the version of the data about the subject detected by the version detecting unit with at least a part of a software version of the image display apparatus, and controls processing of the data about the subject based on whether at least the part of the version of the data about the subject is identical with at least the part of the software version; and
an output unit that outputs warning information when at least the part of the version of the data about the subject is not identical with at least the part of the software version, the warning information indicating that the version of the data about the subject is not identical with the software version.

2. The image display apparatus according to claim 1, further comprising a storage unit that stores a difference between at least the part of the version of the data about the subject detected by the version detecting unit and at least the part of the software version.

3. The image display apparatus according to claim 1, wherein the data about the subject is examination data containing at least an in-vivo image of the subject or report data created based on the examination data.

4. The image display apparatus according to claim 3, wherein the examination data contains type-version information about a type and a version of image processing that has been performed on the examination data.

5. The image display apparatus according to claim 4, further comprising an input unit that receives an image processing request to the control unit, wherein
the control unit compares a type and at least a part of a software version of an image processing function of the image display apparatus with the type-version information, and determines whether the image processing function includes image processing that has not been performed on the examination data,
when the image processing function includes the image processing that has not been performed on the examination data, the control unit causes the output unit to output information for inquiring whether to perform the image processing that has not been performed on the examination data based on the image processing request.

6. The image display apparatus according to claim 3, wherein
when the report data contains an item not compatible with the image display apparatus or data about characters exceeding an upper limit of the number of characters that can be contained in the report data, the control unit causes the output unit to output information indicating that the report data contains data that cannot be displayed.

7. The image display apparatus according to claim 1, wherein
the control unit determines authority of a user who has logged-in the image display apparatus, and
the control unit permits the version of data about the subject to be updated or prohibits updating the version of data about the subject based on the authority of the user.
